(19) United States
(12) Patent Application Publication
(10) Pub. No.: US 2014/0009493 A1
(43) Pub. Date: Jan. 9, 2014

(54) PARALLAX IMAGE GENERATING DEVICE AND PARALLAX IMAGE GENERATING METHOD

(71) Applicant: Kabushiki Kaisha Toshiba, Minato-ku (JP)

(72) Inventor: Tatsuya TANAKA, Kanagawa (JP)

(21) Appl. No.: 13/934,694

(22) Filed: Jul. 3, 2013

(30) Foreign Application Priority Data
Jul. 5, 2012 (JP) 2012-151073

(51) Int. Cl. G06T 11/60

(52) U.S. Cl. CPC G06T 11/60
USPC 345/629

(57) ABSTRACT

According to an embodiment, a parallax image generating device includes an image generator, a determining unit, and an interpolating unit. The image generator generates, from a target image, an image of virtual viewpoint, a viewpoint of the image of virtual viewpoint being different from a viewpoint of the target image. The determining unit determines, which area in the image of virtual viewpoint is an occlusion area. The occlusion area is behind of an object when viewed from the viewpoint of the target image. The interpolating unit interpolates a pixel value of the occlusion area using at least one of the target image and the image of virtual viewpoint along with using a reference image that has already been generated.

### CROSS-REFERENCE TO RELATED APPLICATIONS

This application is based upon and claims the benefit of priority from Japanese Patent Application No. 2012-151073, filed on Jul. 5, 2012; the entire contents of which are incorporated herein by reference.

### FIELD

Embodiments described herein relate generally to a parallax image generating device and a parallax image generating method.

### BACKGROUND

There has been an active development in the area of stereoscopic display devices for consumer use. For example, there are times when the display of three-dimensional images is performed on the basis of two-dimensional images. In such a case, it is necessary to generate images having different viewpoints than the viewpoints of the original two-dimensional images (original images). In order to generate an image having a new viewpoint, it becomes necessary to perform pixel interpolation with respect to the unseen portions of an original image that are in the behind of the objects captured in the image.

However, in the case of sequentially generating parallax images corresponding to different viewpoints than the viewpoint of a target image, there are times when the pixel values of interpolated pixels differ in a substantial manner among the parallax images in the time direction.

### BRIEF DESCRIPTION OF THE DRAWINGS

FIG. 1 is a block diagram illustrating a configuration of a parallax image generating device according to a first embodiment;

FIG. 2 is a block diagram illustrating a detailed configuration of an interpolating unit according to the first embodiment;

FIG. 3 is schematic diagram illustrating the process by which a parallax image generating unit assigns the pixels of an input image to the pixels of an arbitrary-viewpoint image;

FIG. 4 is a flowchart for explaining a sequence of operations performed by the interpolating unit according to the first embodiment;

FIG. 5 is a flowchart for explaining the operations performed by a first interpolation image generating unit according to the first embodiment;

FIG. 6 is a diagram illustrating an example of setting a pixel block;

FIG. 7 is a block diagram illustrating a detailed configuration of an interpolating unit according to a second embodiment;

FIG. 8 is a flowchart for explaining the operations performed by a first interpolation image generating unit according to the second embodiment;

FIG. 9 is a diagram illustrating an example of setting a reference block; and

FIG. 10 is a block diagram illustrating a detailed configuration of an interpolating unit according to a third embodiment.

### DETAILED DESCRIPTION

According to an embodiment, a parallax image generating device includes an image generator, a determining unit, and an interpolating unit. The image generator generates, from a target image, an image of virtual viewpoint, a viewpoint of the image of virtual viewpoint being different from a viewpoint of the target image. The determining unit determines which area in the image of virtual viewpoint is an occlusion area. The occlusion area is in behind of an object when viewed from the viewpoint of the target image. The interpolating unit interpolates a pixel value of the occlusion area using at least one of the target image and the image of virtual viewpoint along with using a reference image that has already been generated.

Various embodiments of a parallax image generating device will be described below with reference to the accompanying drawings. According to each embodiment, the parallax image generating device receives input of an input image (a target image) having a predetermined viewpoint, and generates parallax images having different viewpoints than the viewpoint of the target image. Herein, the target images can be a plurality of parallax images each having a parallax vector, which represents the parallax displacement, attached thereto. Meanwhile, the parallax image generating device is used in televisions (TVs) or personal computers (PCs) that, for example, enable the viewers to view stereoscopic images with the unaided eye or using a pair of 3D glasses.

### First Embodiment

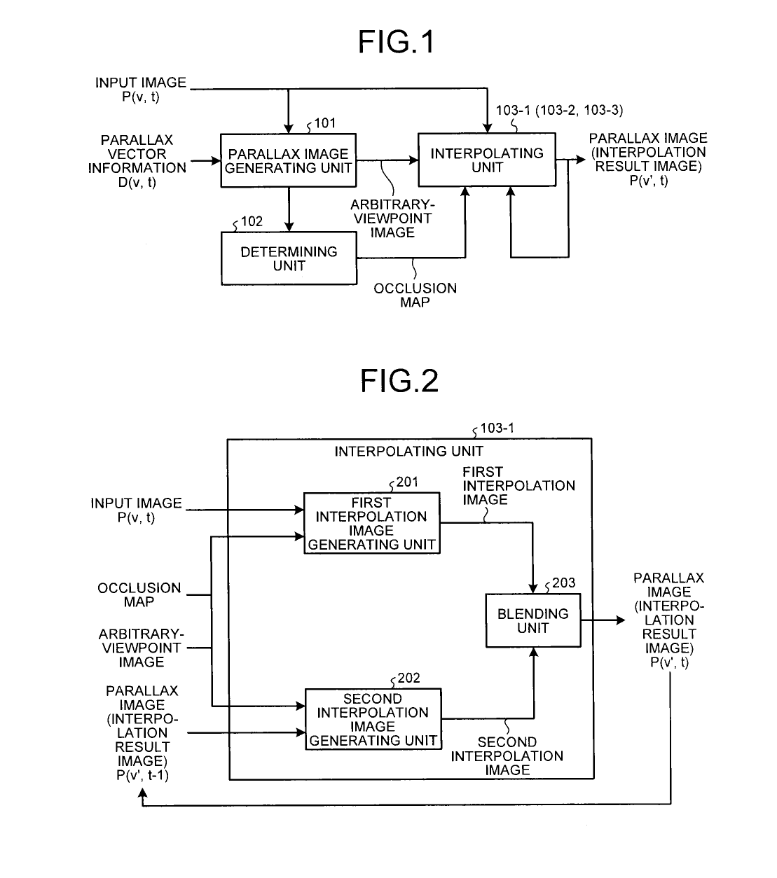

FIG. 1 is a block diagram illustrating a configuration of the parallax image generating device according to a first embodiment. Herein, the parallax image generating device according to the first embodiment includes a parallax image generating unit 101, a determining unit 102, and an interpolating unit 103-1.

The parallax image generating device receives input of, for example, an input image and parallax vector information (described later). An input image points to a target image on which the parallax image generating device performs an operation of generating a parallax image having a different viewpoint.

The parallax image generating device is implemented, for example, in a computer system in which a personal computer is used. Such a computer system includes a central processing unit (CPU), a program memory, and a work memory. When the CPU performs operations according to the instructions that are written in computer programs stored in the program memory, each block constituting the parallax image generating device performs the corresponding functions. Alternatively, each block constituting the parallax image generating device can be partially or entirely configured using hardware.

The CPU reads an input image as well as parallax vector information from a memory medium, which either is installed in the computer system or is connected to the computer system. Alternatively, an input image can be input to the parallax image generating device via a network. The parallax image generating device may include a unit for generating input images and parallax vector information.

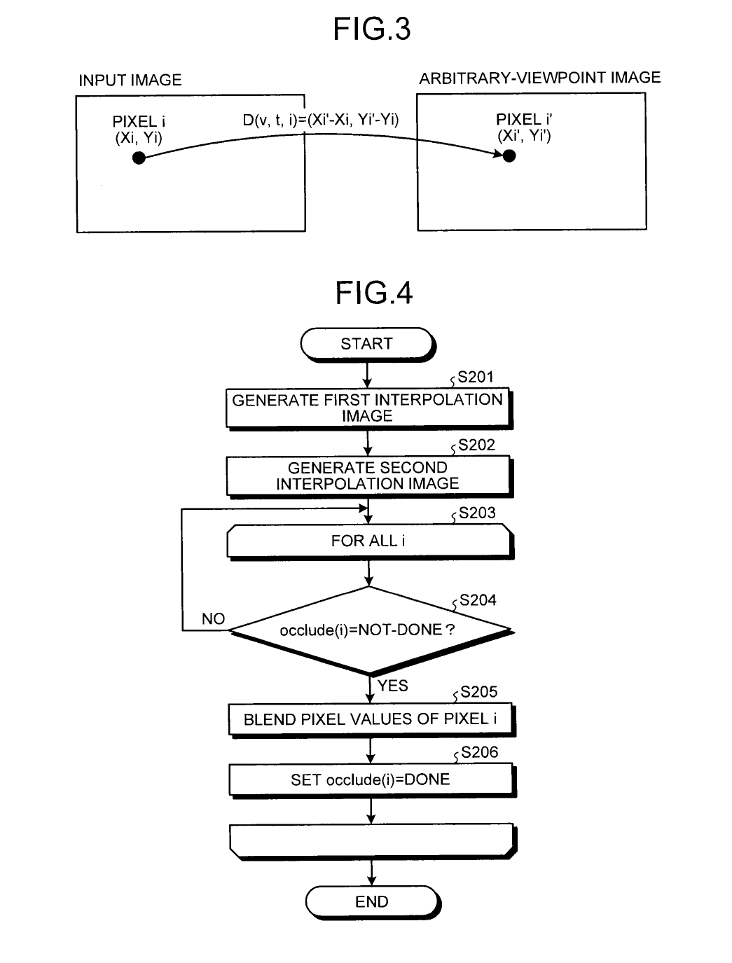

The parallax image generating unit 101 receives input of an input image and parallax vectors. Then, from the input image, the parallax image generating unit 101 generates an arbitrary-viewpoint image that, as its viewpoint, has an arbitrary position based on a parallax vector. FIG. 3 is schematic diagram illustrating the process by which the parallax image generating unit 101 assigns the pixels (the pixel values) of an input image to the pixels of an arbitrary-viewpoint image. As illustrated in FIG. 3, the parallax image generating unit 101 assigns the pixel value of a pixel i, which is positioned at a coordinate (Xi, Yi) in a parallax image that is viewed from a viewpoint v at a timing t, to a pixel i′, which is positioned at a coordinate (Xi′, Yi′) in an arbitrary-viewpoint image. In this way, an arbitrary-viewpoint image is generated when the parallax image generating unit 101 assigns the pixel value of each pixel in an input image to the position indicated by the corresponding parallax vector. The parallax image generating unit 101 then outputs the arbitrary-viewpoint image to the determining unit 102 and the interpolating unit 103-1.

In the arbitrary-viewpoint image received from the parallax image generating unit 101, the determining unit 102 determines which areas have pixel values assigned thereto and which areas do not have pixel values assigned thereto. Then, the determining unit 102 generates an occlusion map and stores it in, for example, a memory (not illustrated).

In an occlusion map “occlude(i)”; if the pixel of a position vector i in an arbitrary-viewpoint image has a pixel value assigned thereto, then occlude(i)=DONE is set. On the other hand, if the pixel of the position vector i does not have a pixel value assigned thereto; then occlude(i)=NOT-DONE is set. Then, the determining unit 102 outputs the occlusion map to the interpolating unit 103-1.

In the following explanation, if an area in the input image is in behind of an object and therefore if the corresponding area in the arbitrary-viewpoint image does not have pixel values assigned thereto; then that area in the arbitrary-viewpoint image is referred to as an occlusion area. Moreover, in the arbitrary-viewpoint image, from among the pixels having pixel values assigned thereto, the pixels having pixel values of low degrees of confidence can be considered to be the pixels included in an occlusion area. For example, consider the case of such pixels in an input image which are present near the boundary of an object and the shadow of that object. Even if such pixels are not in the shadow of the object, the pixel values thereof are likely to be affected by the object. Hence, there are times when those pixels values differ in a substantial manner from the pixel values of the surrounding pixels. In such a case, the pixels having pixel values of lower degrees of confidence are considered to be the pixels included in an occlusion area.

The interpolating unit 103-1 receives the arbitrary-viewpoint image from the parallax image generating unit 101 and receives the occlusion map from the determining unit 102. Besides, the interpolating unit 103-1 also receives the input image. Then, with respect to the pixels in the occlusion area that are identified in the occlusion map and that do not have pixel values assigned thereto, the interpolating unit 103-1 assigns pixels values with the aim of interpolating the arbitrary-viewpoint image.

Explained below in detail with reference to FIG. 2 is the interpolating unit 103-1. FIG. 2 is a block diagram illustrating a detailed configuration of the interpolating unit 103-1 according to the first embodiment. As illustrated in FIG. 2, the interpolating unit 103-1 includes a first interpolation image generating unit 201, a second interpolation image generating unit 202, and a blending unit 203.

The first interpolation image generating unit 201 generates a first interpolation image based on the input image, the arbitrary-viewpoint image, and the occlusion map. The second interpolation image generating unit 202 generates a second interpolation image based on a parallax image that is viewed at a different timing and in which occlusion interpolation is already completed (i.e., on the basis of an interpolation result image), based on the arbitrary-viewpoint image, and based on the occlusion map.

The blending unit 203 receives the first interpolation image from the first interpolation image generating unit 201 and receives the second interpolation image from the second interpolation image generating unit 202. Then, the blending unit 203 performs weighted addition as given below in Expression 1 so as to blend the pixel values of the first interpolation image and the pixel values of the second interpolation image; and generates and outputs a final interpolation result image.

P(v′,t,i)=(1−λ)×P₁(v′,t,i)+λ×P₂(v′,t,i) (1)

In Expression 1, P(v′, t, i) represents the pixel value of the pixel i when a parallax image viewed from the viewpoint v′ at the timing t is generated. Moreover, P1(v′, t, i) and P2(v′, t, i) respectively represent the pixel value of the pixel i in the first interpolation image and the pixel value of the pixel i in the second interpolation image when the parallax image viewed from the viewpoint v′ at the timing t is generated. Furthermore, λ represents a coefficient for determining the blending ratio of the first interpolation image and the second interpolation image. For example, an increase in λ leads to a higher blending ratio of the second interpolation image, and the pixel values in the interpolation result image move closer to the pixel values in the second interpolation image. That is, it becomes possible to reduce the number of times when the pixel values of interpolated pixels differ in a substantial manner among the parallax images in the time direction.

On the other hand, a decrease in λ leads to a higher blending ratio of the first interpolation image, and an interpolation result is obtained in which the pixel values of the input image at the current timing are given more consideration. The value of λ can be a constant number or can be a user-specified value. Then, the blending unit 203 performs the abovementioned operations with respect to all pixels i, and blendes the first interpolation image and the second interpolation image so as to generate a final interpolation result image.

Meanwhile, alternatively, the configuration can be such that the interpolating unit 103-1 performs the blending operation according to Expression 1 given above with respect to only those pixels which are determined to be in an occlusion area (i.e., with respect to the pixels for which occlude(i)=NOT-DONE is set). In this case, the blending unit 203 too receives the occlusion map. Still alternatively, for example, instead of only blending the pixel values at the position of the pixel i, the interpolating unit 103-1 can be to perform weighted addition of the pixels in the neighborhood of the pixel i as given below in Expression 2. Herein, in Expression 2, N represents a set of pixels in the neighborhood of the pixel i; and w(i, j) represents the weight in the case of adding a pixel j. For example, w(i, j) can be a Gauss function or the like in which, closer a pixel to the pixel i, the greater becomes the weight thereof.

$$P ( {v}^{′} , t , i ) = ( 1 - λ ) {\sum }_{j ∈ N} w ( i , j ) \cdot {P}_{1} ( {v}^{′} , t , j ) + λ {\sum }_{j ∈ N} w ( i , j ) \cdot {P}_{2} ( {v}^{′} , t , j ) \qquad ( 2 )$$

Given below is the explanation about a sequence of operations performed by the interpolating unit 103-1 according to the first embodiment. FIG. 4 is a flowchart for explaining the sequence of operations performed by the interpolating unit 103-1 according to the first embodiment. As illustrated in FIG. 4, the first interpolation image generating unit 201 refers to the values in the occlusion map occlude(i) and generates a first interpolation image by assigning, based on the pixel values of an input image or the pixel values of a non-occlusion area, pixel values to all pixels at the positions i that do not have pixel values assigned thereto (Step S201).

The second interpolation image generating unit 202 refers to the values in the occlusion map occlude(i) and generates a second interpolation image by assigning, based on an interpolation result image that is viewed at a different timing and in which interpolation is already completed, pixel values to all pixels at the positions not having pixel values assigned thereto (Step S202).

Then, the blending unit 203 sequentially selects the pixels indicted by the position vector i as the target pixel for processing (Step S203). Subsequently, the blending unit 203 refers to the values in the occlusion map occlude(i) and determines whether or not each selected pixel is in an occlusion area determined by the determining unit 102 (Step S204).

If the selected pixel has a pixel value assigned thereto (No at Step S204), then the blending unit 203 changes the position i of the target pixel for processing. Then, the system control returns to Step S203. On the other hand, if the selected pixel does not have a pixel value assigned thereto (Yes at Step S204), then the blending unit 203 blendes the pixel value of the first interpolation image and the pixels value of the second interpolation image according to Expression 1 given above (Step S205).

Subsequently, the interpolating unit 103-1 sets occlude(i)=DONE and changes the target pixel for processing to the next pixel (Step S206).

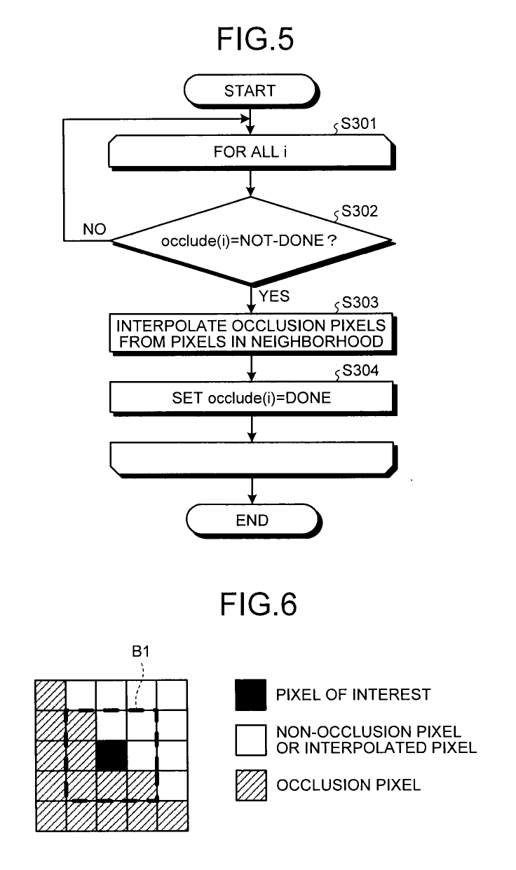

Explained below in detail with reference to FIGS. 5 and 6 are the operations performed by the first interpolation image generating unit 201. FIG. 5 is a flowchart for explaining the operations performed by the first interpolation image generating unit 201. As illustrated in FIG. 5, the first interpolation image generating unit 201 selects the pixel indicated by the position vector i as the target pixel for processing (Step S301).

Then, the first interpolation image generating unit 201 determines whether or not occlude(i)=NOT-DONE is set for the pixel at the position i (Step S302). That is, the first interpolation image generating unit 201 determines whether or not the pixel at the position i belongs to an occlusion area in which pixel values are not assigned.

If occlude(i)=DONE is set for the pixel at the position i and if the pixel has a pixel value assigned thereto (No at Step S302), then the first interpolation image generating unit 201 changes the position i of the target pixel for processing according to the raster scan order. Then the system control returns to Step S301. When the position i of the target pixel for processing reaches the end of the image, the first interpolation image generating unit 201 ends the operations.

Meanwhile, if occlude(i)=NOT-DONE is set for the pixel at the position i and if the pixel does not have a pixel value assigned thereto (Yes at Step S302), then the first interpolation image generating unit 201 sets the pixel as the target pixel for processing. Then, with respect to the target pixel for processing, the first interpolation image generating unit 201 interpolates the occlusion (the occlusion pixels) using Expression 3 given below and based on the pixel values of pixels included in a pixel block B1.

$$P ( {v}^{′} , t , i ) = \frac{{\sum }_{j ∈ {B}_{1}} ( {B}_{1} ( j ) \times α ( j ) )}{{\sum }_{j ∈ {B}_{1}} α ( j )} \qquad ( 3 )$$

Herein, α(j) represents a variable that takes the value “1” when occlude(j)=DONE is set and takes the value “0” when occlude(j)=NOT-DONE is set. Moreover, B₁(j) represents a pixel block of m×n pixels (m and n are integers where m≧1, n≧1, and m×n>2) around the pixel i.

FIG. 6 is a diagram illustrating an example of setting a pixel block. In FIG. 6, as illustrated by dashed lines, the pixel block B1 of 3×3 pixels is set around the target pixel for processing. Expression 3 given above means that the pixel value of the target pixel for processing is interpolated with the average of the pixel values of either the non-occlusion pixels or the interpolated pixels included within the dashed lines illustrated in FIG. 6. Meanwhile, the setting of a pixel block is not limited to the example given above. Alternatively, for example, a pixel block can be set in such a way that the percentage of pixels belonging to a non-occlusion area increases within the pixel block.

Moreover, the interpolation of pixel values is also not limited to Expression 3 given above. Alternatively, for example, the first interpolation image generating unit 201 can make use of a Gaussian filter or a bilateral filter in such a way that, shorter the spatial distance or the distance in the color space from a pixel to the target pixel i for processing and a neighborhood pixel j of the target pixel i, the higher is the weight attached to that pixel. Then, the weighted average can be calculated. Still alternatively, in the case when depth information with respect to each pixel in an image is available by means of image analysis or by using a depth sensor, the first interpolation image generating unit 201 can perform processing in such a way that the pixels which correspond to pixels representing a distant background are given higher weights.

Subsequently, the first interpolation image generating unit 201 sets occlude(i)=DONE and changes the target pixel for processing to the next pixel (Step S304).

Given below is the explanation about the operations performed by the second interpolation image generating unit 202. Herein, the only difference between the second interpolation image generating unit 202 and the first interpolation image generating unit 201 is in the method of setting the pixel block B1. In the first interpolation image generating unit 201, a pixel block is set in a non-occlusion area of an input image or an arbitrary-viewpoint image. In contrast, in the second interpolation image generating unit 202, a pixel block (referred to as a pixel block B2) is set in an interpolation result image that is viewed at a different timing and in which interpolation is already completed. For example, as the pixel block B2, the second interpolation image generating unit 202 sets a pixel block around such a pixel in the interpolation result image that is at the same position as the position of the target pixel for processing. Alternatively, the second interpolation image generating unit 202 can make use of a motion search technology and set a pixel block B2 in the interpolation result image around a position that is obtained by adding, as an offset to the target pixel for processing, the movement of pixels between the interpolation result image and the arbitrary-viewpoint image.

Then, in an identical manner to the first interpolation image generating unit 201, the second interpolation image generating unit 202 interpolates the pixel value at the position i with the average of the pixel values having occlude(j)=DONE set in the pixel block B2. Herein, in place of B₁(j) specified in Expression 3 given above, the second interpolation image generating unit 202 uses B₂(j) that represents the pixel value at the position j in the pixel block B2. Meanwhile, in the interpolation result image; since the interpolation is already completed, all pixels belong to the non-occlusion areas (in which occlude(j)=DONE is set).

Still alternatively, instead of performing the averaging operation using Expression 3 given above; the second interpolation image generating unit 202 can assign, without modification, the pixel value of that pixel in the interpolation result image which corresponds to the target pixel for processing. Meanwhile, the other operations performed by the second interpolation image generating unit 202 are identical to the operations performed by the first interpolation image generating unit 201.

In this way, in the parallax image generating device according to the first embodiment; the pixel values of a first interpolation image, in which interpolation is performed using the non-occlusion areas present in an input image or an arbitrary-wavelength image, and the pixel values of a second interpolation image, in which interpolation of an occlusion area is performed using an interpolation result image that is viewed at a different timing and in which interpolation is already completed, are subjected to weighted addition. As a result, it becomes possible to reduce the discontinuity when the pixel values of interpolated pixels differ in a substantial manner among the parallax images in the time direction. Besides, parallax images having a more natural look can be provided.

### Second Embodiment

In the first embodiment, the first interpolation image generating unit 201 as well as the second interpolation image generating unit 202 interpolates the pixel values in an occlusion area by using the linear sum of the pixel values of the pixels positioned in the neighborhood of the pixels belonging to the occlusion area; and performs weighted addition of the first interpolation image and the second interpolation image to generate the final interpolation result image. In contrast, in a second embodiment, instead of interpolating the pixel values in an occlusion area by taking the linear sum of the pixels positioned in the neighborhood of the pixels belonging to the occlusion area, pixel values suitable for the interpolation of the occlusion area are retrieved from a non-occlusion area and are assigned to the occlusion area with the aim of interpolating the occlusion. In addition, as compared to the first embodiment, the second embodiment differs in the way that weight coefficients with respect to the blending unit 203 are adjusted based on the degrees of similarity obtained as a result of retrieving the pixel values used in the interpolation of the occlusion area.

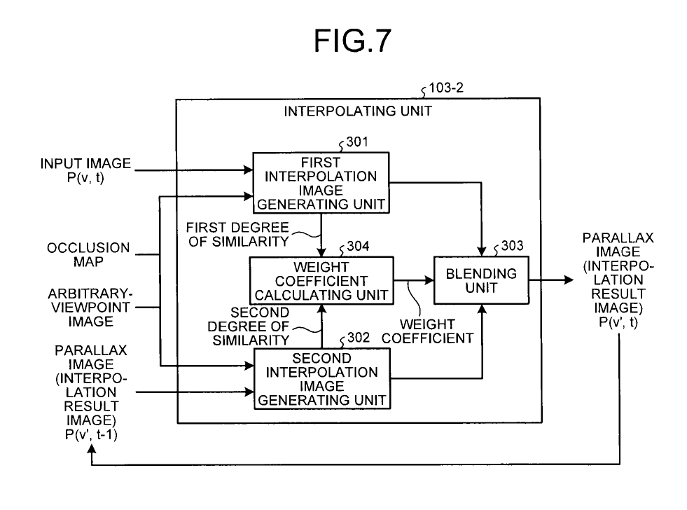

Given below is the explanation of the parallax image generating device according to the second embodiment. FIG. 7 is a block diagram illustrating a detailed configuration of an interpolating unit 103-2 according to the second embodiment. However, the overall configuration of the parallax image generating device according to the second embodiment is identical to the configuration of the parallax image generating device illustrated in FIG. 1 according to the first embodiment.

In the parallax image generating device according to the second embodiment, the interpolating unit 103-2 includes a first interpolation image generating unit 301, a second interpolation image generating unit 302, a blending unit 303, and a weight coefficient calculating unit 304. The first interpolation image generating unit 301, the second interpolation image generating unit 302, and the blending unit 303 respectively perform different operations than the first interpolation image generating unit 201, the second interpolation image generating unit 202, and the blending unit 203 according to the first embodiment.

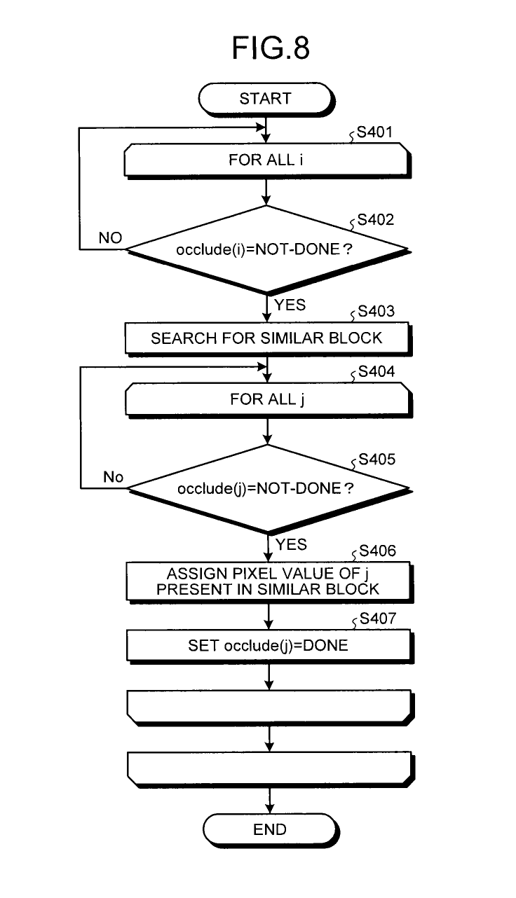

FIG. 8 is a flowchart for explaining the operations performed by the first interpolation image generating unit 301 according to the second embodiment. As illustrated in FIG. 8, the first interpolation image generating unit 301 performs operations with respect to the pixel that is specified by the position vector i in an arbitrary-viewpoint image (Step S401).

The first interpolation image generating unit 301 refers to the values in the occlusion map occlude(i) for the pixel at the position i and determines whether or not the pixel at the position i has a pixel value assigned thereto (Step S402).

If the pixel at the position i has a pixel value assigned thereto (No at Step S402), then the operations are performed with respect to the next pixel.

On the other hand, if the pixel at the position i does not have a pixel value assigned thereto (Yes at Step S402), then the first interpolation image generating unit 301 searches in a search scope W1 for a block (a first similar block) that is similar to the pixel block including the position i (a reference block) by means of template matching (Step S403).

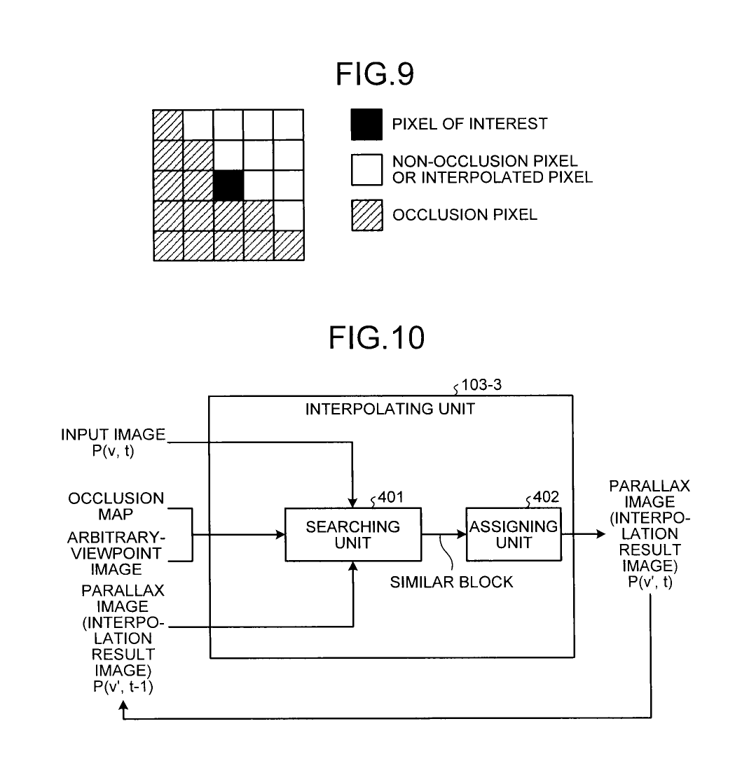

FIG. 9 is a diagram illustrating an example of setting a reference block. In FIG. 9, each square represents a pixel, and a pixel block of 5×5 pixels around the pixel at the position i is set as the reference block. However, the setting of a reference block is not limited to the example illustrated in FIG. 9. Alternatively, for example, a pixel block can be set in such a way that the percentage of pixels belonging to a non-occlusion area increases within the reference block. Moreover, the size of the pixel block is also not limited to 5×5 pixels. Alternatively, for example, a block size of m×n pixels (m and n are integers where m≧1, n≧1, and m×n>2) can also be set.

The following explanation is given regarding searching for the first similar block. The first interpolation image generating unit 301 sets a predetermined search scope W1 in an input image or an arbitrary-viewpoint image that is received as input. The search scope W1 can be set, for example, in the neighborhood of the pixel i in the arbitrary viewpoint image. Alternatively, the search scope W1 can be set in the neighborhood of those pixels in the input image which correspond to the pixels belonging to a non-occlusion area adjacent to the pixel i.

Upon setting the search scope W1; the first interpolation image generating unit 301 sets, in the search scope W1, a candidate target block of the same size as the size of the reference block. It is assumed that the candidate target block does not include any pixels that do not have pixel values assigned thereto. Moreover, it is also possible to set a plurality of candidate target blocks.

The first interpolation image generating unit 301 searches the candidate target blocks, which are set in the search scope W1, for a target block that is most similar to the reference block set with respect to the pixel of interest i; and selects that target block. For example, the degree of similarity between the reference block and the target block can be obtained based on the sum of squared difference using Expression 4 given below.

$${S}_{SSD} ( i ) = \frac{C}{{{\sum }_{j ∈ R ,}}_{occlude ( j ) = DONE} {( R ( j ) - T ( j ) )}^{2} + ɛ} \qquad ( 4 )$$

In Expression 4, R(j) represents the pixel value at the position j in the reference block and T(j) represents the pixel value at the position j in the candidate target block. Moreover, C represents a constant number, and E represents a constant number for avoiding division by zero. Meanwhile, in the case of calculating the sum of squared difference, only the pixels for which occlude(j)=DONE is set are taken into account. For example, in the example illustrated in FIG. 9, in the reference block and the candidate target blocks, the sum of square difference is calculated from the pixels at the pixel positions illustrated with white color in FIG. 9. In order to search for the first similar block, the first interpolation image generating unit 301 searches for the candidate target block which leads to maximization of the degree of similarity obtained in the manner described above. Meanwhile, alternatively, the first interpolation image generating unit 301 can calculate the degree of similarity based on the sum of absolute difference using Expression 5 given below.

$${S}_{SAD} ( i ) = \frac{C}{{{\sum }_{j ∈ R ,} }_{occlude ( j ) = DONE} \vert R ( j ) - T ( j ) \vert + ɛ} \qquad ( 5 )$$

Herein, the definition of the degree of similarity is not limited to the reciprocal number of the sum of squared difference or the reciprocal number of the sum of absolute difference. Alternatively, the degree of similarity can be defined in such a way that, smaller the difference in pixel values of blocks, the higher becomes the degree of similarity. Meanwhile, the search scope W1 is not limited to a non-occlusion area in an input image or an arbitrary-viewpoint image. Alternatively, the search scope W1 can be set in an input image of a different timing.

Then, the first interpolation image generating unit 301 sets a position vector j for scanning the inside of the first similar block in the raster scan order (Step S404).

Subsequently, the first interpolation image generating unit 301 determines whether or not occlude(j)=NOT-DONE is set for the pixel at the position vector j (Step S405).

If occlude(j)=NOT-DONE is set for the pixel at the position vector j (Yes at Step S405), then the first interpolation image generating unit 301 assigns the pixel value of the pixel at the position vector j in the first similar block to the pixel at the position vector j in the reference block (Step S406).

Moreover, the first interpolation image generating unit 301 changes the setting to occlude(j)=DONE for the pixel at the position vector j (Step S407).

On the other hand, if occlude(j)=DONE is set for the pixel at the position vector j (No at Step S405), then the first interpolation image generating unit 301 changes the position vector j according to the raster scan order and repeats the abovementioned operations. Then, the system control returns to Step S301. Once the position vector j completes the scanning inside the reference block, the first interpolation image generating unit 301 changes the position vector i of the target pixel for processing according to the raster scan order. Then, the system control returns to Step S401 and the abovementioned operations are repeated. When scanning of all positions i is completed, the first interpolation image generating unit 301 ends the operations.

In this way, from the search scope W1, the first interpolation image generating unit 301 retrieves pixel values that are suitable for the interpolation of the occlusion area, and assigns those pixel values to the occlusion area with that aim of interpolating the occlusion. Then, the first interpolation image generating unit 301 outputs the first interpolation image as well as outputs a first degree of similarity calculated with respect to each pixel in the occlusion area during the template matching performed at the time of generating the first interpolation image.

Given below is the explanation about the second interpolation image generating unit 302. The operations performed by the second interpolation image generating unit 302 are identical to the operations performed by the first interpolation image generating unit 301, and are illustrated in the flowchart in FIG. 8. However, as compared to the first interpolation image generating unit 301, the second interpolation image generating unit 302 differs in the way that the search scope W1 is not set in an input image or an arbitrary-viewpoint image but is set (as a search scope W2) in an interpolation result image that is viewed at a different timing and in which interpolation is already completed. Meanwhile, the other operations performed by the second interpolation image generating unit 302 are identical to the operations performed by the first interpolation image generating unit 301.

The second interpolation image generating unit 302 outputs the second interpolation image as well as outputs a second degree of similarity calculated with respect to each pixel in the occlusion area during the template matching performed at the time of generating the second interpolation image.

Based on the first degree of similarity output by the first interpolation image generating unit 301 and based on the second degree of similarity output by the second interpolation image generating unit 302, the weight coefficient calculating unit 304 calculates the weight coefficient on a pixel-by-pixel basis in the occlusion area using Expression 6 given below.

$$λ ( i ) = \frac{{S}_{2} ( i )}{{S}_{1} ( i ) + {S}_{2} ( i ) + ɛ} \qquad ( 6 )$$

In Expression 6, S₁ represents the first degree of similarity and S₂ represents the second degree of similarity. Moreover, ε represents a constant number for avoiding division by zero. However, the method of calculating the weight coefficient is not limited to the above-mentioned method. Alternatively, the weight coefficient can be set in such a way that, higher the degree of similarity of a pixel, the higher becomes the blending ratio thereof. The weight coefficient calculating unit 304 outputs the calculated weight coefficient to the blending unit 303.

Then, based on the weight coefficient output by the weight coefficient calculating unit 304, the blending unit 303 blendes the pixel values of the first interpolation image and the pixel values of the second interpolation image using Expression 7 given below.

P(v′,t,i)=(1−λ(i))×P₁(v′,t,i)+λ(i)×P₂(v′,t,i) (7)

In this way, in the parallax image generating device according to the second embodiment, the pixel values of an occlusion area are not interpolated using the linear sum of the pixels positioned in the neighborhood of the pixels belonging to the occlusion area. Instead, pixel values suitable for the interpolation of the occlusion area are retrieved from a particular search scope and are assigned to the occlusion area so as to interpolate the occlusion. As a result, while generating the first interpolation image and the second interpolation image, it becomes possible to interpolate the pixels in the occlusion area having reduced blurring.

Moreover, in the parallax image generating device according to the second embodiment, while performing weighted addition of pixels, the blending unit 303 makes use of the weight coefficients calculated by the weight coefficient calculating unit 304 based on the first degree of similarity and the second degree of similarity. Hence, in the parallax image generating device according to the second embodiment, blending of the two interpolation images can be performed by giving weight to the result of a high degree of confidence. As a result, it becomes possible to reduce the discontinuity when the pixel values of interpolated pixels differ in a substantial manner among the parallax images in the time direction. Besides, in the parallax image generating device according to the second embodiment, it becomes possible to perform pixel interpolation of an occlusion area in a natural way.

### Third Embodiment

In the second embodiment, the first interpolation image generating unit 301 as well as the second interpolation image generating unit 302 generates an interpolation image. Then, a final interpolation result image is generated by performing weighted addition of the two interpolation images on the basis of the degrees of similarity output as a result of various operations. In contrast, a third embodiment differs in the way that the operations performed by the first interpolation image generating unit 301 and the operations performed by the second interpolation image generating unit 302 according to the second embodiment are integrated; and that the weight coefficient calculating unit 304 and the blending unit 303 are absent.

FIG. 10 is a block diagram illustrating a detailed configuration of an interpolating unit 103-3 according to the third embodiment. As illustrated in FIG. 10, the interpolating unit 103-3 includes a searching unit 401 and an assigning unit 402.

The searching unit 401 and the assigning unit 402 perform identical operations to the operations performed by the first interpolation image generating unit and the second interpolation image generating unit illustrated in FIG. 8. However, as compared to the second embodiment, the third embodiment differs in the way that the searching unit 401 of the interpolating unit 103-3 searches for a scope that is a combination of the search scopes W1 and W2 described in the second embodiment.

The searching unit 401 searches in the search scopes W1 and W2 for the similar block having the highest degree of similarity and outputs that similar block to the assigning unit 402. Then, the assigning unit 402 performs the operations from Step S404 to Step S407 illustrated in FIG. 8 and assigns the pixel values of the similar block to the pixels of the occlusion area.

In the third embodiment, the searching unit 401 searches in the search scope W1 as well as the search scope W2 for a similar block. Then, the pixel values of the similar block that is retrieved are assigned to the pixels of the occlusion area. Hence, not only it becomes unnecessary to have a memory for holding a first interpolation image and a second interpolation image, it also becomes possible to eliminate the operations related to the weighted addition of the first interpolation image and the second interpolation image. Meanwhile, for example, the setting can be such that the searching unit 401 performs the search only in the search scope W2. In that case, interpolation of the occlusion area can be performed by taking into account only the changes in the pixel values of the interpolated occlusion area.

In this way, in the parallax image generating device according to the embodiments described above, at least one of a target image and an arbitrary-viewpoint image is used along with an already-generated parallax image for interpolating an occlusion area in the arbitrary-viewpoint image. For that reason, even in the case of sequentially generating parallax images corresponding to different viewpoints than the viewpoint of the target image; it becomes possible to reduce the discontinuity when the pixel values of interpolated pixels differ in a substantial manner among the parallax images in the time direction.

Meanwhile, in the parallax image generating device, the raster scan order is given as an example of the order for scanning images. However, the order for scanning images is not limited to the raster scan order. Alternatively, images can be scanned in the order of scanning all areas of the images. Moreover, an input image can have two or more viewpoints, and a parallax image that is generated can have three or more viewpoints.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parallax image generating device comprising:
an image generator to generate, from a target image, an image of virtual viewpoint, a viewpoint of the image of virtual viewpoint being different from a viewpoint of the target image;
a determining unit to determine which area in the image of virtual viewpoint is an occlusion area, the occlusion area being in behind of an object when viewed from the viewpoint of the target image; and
an interpolating unit to interpolate a pixel value of the occlusion area using at least one of the target image and the image of virtual viewpoint along with using a reference image that has already been generated.

2. The device according to claim 1, wherein
the interpolating unit includes
a first generator to generate a first image by interpolating the pixel value of the occlusion area using pixel values of at least one of the target image and the image of virtual viewpoint; and
a second generator to generate a second image by interpolating the pixel value of the occlusion area using the reference image, and
the interpolating unit to interpolate the pixel value of the occlusion area based on the a first image and the second image.

3. The device according to claim 2, wherein
the interpolating unit further includes a blending unit to generate a blended image by blending the first image and the second image, and
the interpolating unit interpolates the pixel value of the occlusion area according to the blended image.

4. The device according to claim 3, wherein
the first generator searches at least one of the target image and the image of virtual viewpoint for a first similar block that is similar to a reference block including a pixel of interest which belongs to the occlusion area, and generates the first image based on a search result, and
the second generator searches the parallax image, which has already been generated, for a second similar block that is similar to the reference block including the pixel of interest which belongs to the occlusion area, and generates the second image based on a search result.

5. The device according to claim 4, wherein
the interpolating unit further includes a weighed coefficient calculator to calculate a weighted coefficient according to degrees of similarity between pixels in the reference block and pixels in the first image and according to degrees of similarity between pixels in the reference block and pixels in the second image, and
the blending unit varies a blending ratio of the first image and the second image according to the weighted coefficient.

6. The device according to claim 1, wherein
the interpolating unit includes a searching unit to search the target image, the image of virtual viewpoint, and the parallax image, which has already been generated, for a similar block that is similar to a reference block including a pixel of interest which belongs to the occlusion area, and
the interpolating unit interpolates the pixel value of the occlusion area based on pixel values in the similar block thus searched for by the searching unit.

7. The device according to claim 1, wherein
a viewpoint of the reference image is equal to the viewpoint of the image of virtual viewpoint, and
timing to display the reference image is not equal to timing to display the image of virtual viewpoint.

8. The device according to claim 1, wherein
a viewpoint of the reference image is different from the viewpoint of the target image and different from the viewpoint of the image of virtual viewpoint.

9. The device according to claim 1, wherein
the first generator and the second generator operate in parallel.

10. A parallax image generating system
to generate, from a target image, an image of virtual viewpoint, a viewpoint of the image of virtual viewpoint being different from a viewpoint of the target image;
to determine which area in the image of virtual viewpoint is an occlusion area, the occlusion area being behind of an object when viewed from the viewpoint of the target image; and
to interpolate a pixel value of the occlusion area using at least one of the target image and the image of virtual viewpoint along with using a reference image that has already been generated.

11. A parallax image generating method comprising:
generating, from a target image, an image of virtual viewpoint, a viewpoint of the image of virtual viewpoint being different from a viewpoint of the target image;
determining, which area in the image of virtual viewpoint is an occlusion area, the occlusion area being behind of an object when viewed from the viewpoint of the target image; and
interpolating a pixel value of the occlusion area using at least one of the target image and the image of virtual viewpoint along with using a reference image that has already been generated.
